(19) United States
(12) Patent Application Publication
(10) Pub. No.: US 2026/0279942 A1
(43) Pub. Date: Sep. 17, 2026

(54) METHOD OF SEPARATING ACTIVE MATERIAL, JIG, AND APPARATUS FOR SEPARATING ACTIVE MATERIAL

(71) Applicant: HONDA MOTOR CO., LTD., Tokyo (JP)

(72) Inventors: Masaaki Fujita, Tokyo (JP); Masafumi Saito, Tokyo (JP); Kiyotaka Isobe, Tokyo (JP)

(21) Appl. No.: 19/550,328

(22) Filed: Feb. 26, 2026

(30) Foreign Application Priority Data
Mar. 11, 2025 (JP) 2025-038316

(51) Int. Cl. H01M 10/54; B03B 5/68

(52) U.S. Cl. CPC H01M 10/54; B03B 5/68

(57) ABSTRACT

This method of separating an active material includes a process of attaching a battery member containing an active material to a front surface of a foldable jig, a process of folding a side of the front surface of the jig before and after the battery member is attached thereto to form a mountain shape, a process of disposing the jig to which the battery member is attached in an apparatus for separating an active material with the mountain-shaped top portion facing upward, a process of disposing an injection nozzle configured to inject an injection material containing liquid or particles onto an active material separation surface of the battery member above the jig disposed in the separating apparatus, and a process of injecting the injection material from the injection nozzle toward tilted front surfaces of the mountain-shaped jig and separating the active material from the battery member.

### CROSS-REFERENCE TO RELATED APPLICATION

The present application claims priority based on Japanese Patent Application No. 2025-038316, filed Mar. 11, 2025, the content of which is incorporated herein by reference.

### BACKGROUND OF THE INVENTION

### Field of the Invention

The present invention relates to an active material separating method of separating an active material from a battery member, a jig, and an active material separating apparatus.

### Description of Related Art

In light of climate-related disasters, there is growing interest in electric vehicles as a way to reduce CO₂ emissions, and the demand for batteries installed in these vehicles is also increasing. In this situation, research into the recycling of battery materials is underway. For example, research is being conducted focusing on an aspect such as high efficiency recovery of the active material used in the electrode, cost reduction of the recovery process, or the like.

For example, Japanese Unexamined Patent Application, First Publication No. 2023-150119 proposes an active material separating apparatus for separating an active material from a discarded battery. The active material separating apparatus disclosed in Japanese Unexamined Patent Application, First Publication No. 2023-150119 injects high-pressure liquid onto the outer surface of a battery member, and the jet flow of the liquid separates the active material from the battery member.

The separating apparatus includes a container in which liquid is stored, a base member (battery support part) configured to support the battery member in the container, and an injection nozzle configured to inject high-pressure liquid from above the liquid surface onto the outer surface of the battery member submerged in liquid. When the active material is separated from the battery member, the battery member is disposed on the base member so that an active material separation surface (separation target surface) of the battery member faces vertically upward, and in this state, liquid is introduced into the container and the battery member is disposed under the liquid surface of the liquid. After that, the high-pressure liquid is injected toward the active material separation surface from above the liquid surface in the container by the injection nozzle.

At this time, the high-pressure liquid injected from the injection nozzle collides with the liquid surface of the liquid in the container, dispersing the injection pressure to the surroundings. Accordingly, this prevents the injection pressure from concentrating in one spot on the outer surface of the battery member. In addition, at this time, since the battery member is positioned below the liquid surface of the liquid, the active material separated from the outer surface of the battery member is prevented from scattering upward.

### SUMMARY OF THE INVENTION

In the above-mentioned separating apparatus in the related art, the high-pressure liquid is injected from the injection nozzle toward the liquid surface where the battery member is submerged. For this reason, the high-pressure liquid injected from the injection nozzle collides with the water surface, and at this time, the energy of the liquid is greatly attenuated. This means unnecessary energy loss from the high-pressure liquids, and improvement is desirable from the viewpoint of effective energy utilization.

In addition, the above-mentioned separating apparatus in the related art separates the active material from the battery member using the liquid jet flow itself, so the range in which the active material on the battery member can be separated is limited to the range in which the jet flow directly hits the active material. For this reason, in order to separate the active material from the entire battery member, the base member that supports the battery member must be moved frequently and finely within the container. This is undesirable from the viewpoint of efficient separation processing of the active material from the battery member, and the development of more efficient separation techniques is desired.

In addition, by increasing the injection pressure of the liquid injected from the injection nozzle, the separation-possible range of the active material can be expanded. However, in this case, the pressure of the liquid jet flow hitting the outer surface of the battery member increases, making the base material of the battery member more likely to deform. Then, if the deformation of the base material of the battery member becomes too large, the subsequent smooth separation of the active material will be hindered.

An aspect of the present invention is directed to providing a method of separating an active material, a jig, and an apparatus for separating an active material, which are capable of continuously and efficiently performing separation work for an active material of a battery member.

In order to accomplish the above-mentioned purposes, a method of separating an active material, a jig, and an apparatus for separating an active material according to aspects of the present invention employ the following configurations.
(1) A first aspect of the present invention is a method of separating an active material, including: a process of attaching a battery member containing an active material to a front surface of a foldable jig; a process of folding a side of the front surface of the jig before and after the battery member is attached thereto to form a mountain shape; a process of disposing the jig to which the battery member is attached in an apparatus for separating an active material with the mountain-shaped top portion facing upward; a process of disposing an injection nozzle configured to inject an injection material containing liquid or particles onto an active material separation surface of the battery member above the jig disposed in the separating apparatus; and a process of injecting the injection material from the injection nozzle toward tilted front surfaces of the mountain-shaped jig and separating the active material from the battery member.
(2) In the aspect of the above-mentioned (1), the process of separating the active material may include a process of moving the injection nozzle parallel to a ridgeline of the top portion and injecting the injection material from the injection nozzle toward the tilted front surfaces of the mountain-shaped jig.
(3) In the aspect of the above-mentioned (1), the process of separating the active material may include a process of moving the injection nozzle in a direction that intersects with the ridgeline of the top portion after injecting the injection material from the injection nozzle toward the tilted front surfaces of the mountain-shaped jig, and injecting the injection material toward the tilted front surfaces on the side of foot portions of the mountain-shaped jig.
(4) In the aspect of the above-mentioned (1), the process of disposing the injection nozzle may include a process of disposing the injection nozzles on symmetrical positions relative to the ridgeline of the top portion, respectively, and the process of separating the active material may include a process of injecting the injection material simultaneously and symmetrically toward the tilted front surfaces of the mountain-shaped jig from the injection nozzles disposed on the symmetrical positions, respectively.
(5) In the aspect of any one of the above-mentioned (1) to (4), the method may further include a process of inputting the jigs to which the battery members are attached in a container in which liquid is stored, and disposing the jigs in the liquid in the container, and the injection nozzle may have a liquid injection part disposed in the liquid in the container, and inject the liquid injection material onto the battery member in the liquid.
(6) In the aspect of the above-mentioned (5), the method may further include a process of disposing the mountain-shaped jigs in the container multiple times, and the plurality of jigs disposed inside the container may be disposed with the ridgelines of the top portions aligned in the same direction and with intervals between the foot portions of the mountain-shaped jigs.
(7) A second aspect of the present invention is a jig having a pair of foldable plate members, a battery member containing an active material being attachable to front surfaces of the plate members, the side of the front surfaces being folded to form a mountain shape, the jig being used in an active material separating apparatus for separating the active material from the battery member.
(8) A third aspect of the present invention is an apparatus for separating an active material, the apparatus including: a jig having a pair of foldable plate members, a battery member containing an active material being attachable to front surfaces of the plate members, the side of the front surfaces being folded in a mountain shape; and an injection nozzle configured to inject an injection material containing liquid or particles onto an active material separation surface of the battery member, the injection material being injected from the injection nozzle toward the tilted front surfaces of the mountain-shaped jig, separating the active material from the battery member.

According to the aspects of the present invention, it is possible to provide a method of separating an active material, a jig, and an apparatus for separating an active material, which are capable of continuously and efficiently performing separation work for an active material of a battery member.

### BRIEF DESCRIPTION OF THE DRAWINGS

FIG. 1 is a schematic view showing a wound body-shaped battery member according to an embodiment.

FIG. 2 is a schematic view showing the battery member cut in a strip shape according to the embodiment.

FIG. 3(A) is a schematic view showing a jig in a deployment state and a strip-shaped battery member according to the embodiment, and FIG. 3(B) is a schematic view showing a state in which the battery member is attached to the jig in the folded state.

FIG. 4 is a perspective view showing a state in which multiple jigs and battery members of FIG. 3(B) are lined up.

FIG. 5(A) is a schematic view showing an apparatus for separating an active material according to the embodiment, and FIG. 5(B) is a schematic view showing a jig disposition portion of the separating apparatus.

FIG. 6 is a schematic view for describing a process of separating an active material according to the embodiment.

FIG. 7(A) is a schematic view showing an aspect in which an active material is separated from the battery member, and FIG. 7(B) is a schematic view showing an aspect after the active material is separated from the battery member.

FIG. 8 is a schematic view showing an aspect in which liquid is injected from the injection nozzle to the battery member.

FIG. 9(A) is a schematic view showing a state in which separation work for an active material is terminated by the apparatus for separating the active material, and FIG. 9(B) is a schematic view showing a state in which the plurality of jigs extracted from the separating apparatus and folded are lined up.

FIG. 10(A) is a schematic view for describing a first process of turning the battery member upside down and attaching the battery member to another jig, FIG. 10(B) is a schematic view for describing a second process after FIG. 10(A), and FIG. 10(C) is a schematic view for describing a third process after FIG. 10(B).

FIG. 11 is a schematic view for describing a process of separating an active material of the battery member attached to the other jig.

FIG. 12 is a schematic view for describing a process of removing the battery member attached to the other jig and separating the battery member from the jig.

FIG. 13 is a flowchart showing a method of separating an active material according to the embodiment.

### DESCRIPTION OF EMBODIMENTS

Hereinafter, an embodiment of the present invention will be described with reference to the accompanying drawings. Further, in the specification and drawings, components having substantially the same functional configuration are designated by the same reference numerals to omit redundant description.

### Battery Member 10

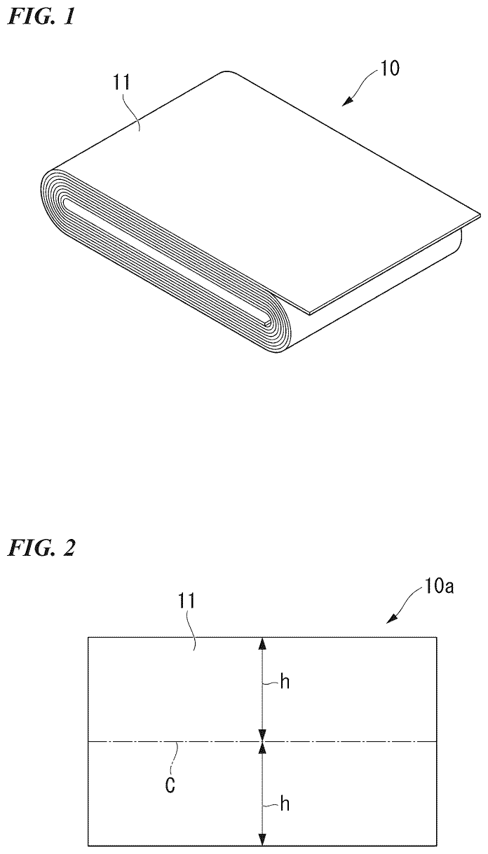

Referring to FIG. 1 and FIG. 2, a battery member 10 according to the embodiment will be described. FIG. 1 is a perspective view showing the battery member 10 having a wound body shape according to the embodiment. FIG. 2 is a plan view showing a strip-shaped battery member 10a according to the embodiment.

The battery member 10 is used, for example, in an electrode of a battery installed in an electric vehicle, and contains an active material 11 and, if necessary, a binder or conductive additives.

The active material 11 is a positive electrode active material or a negative electrode active material. The positive electrode active material is not particularly limited, but for example, contains Li. Examples of the active material 11 may include a layered positive electrode active material, a spinel type positive electrode active material, an olivine type positive electrode active material, and the like. Examples of the layered positive electrode active material may include LiCoO₂, LiNiO₂, LiCo₁/₃Ni₁/₃Mn₁/₃O₂, and the like. Examples of the spinel type positive electrode active material may include LiMn₂O₄, LiCoMnO₄, Li₂NiMn₃O₈, and the like. Examples of the olivine type positive electrode active material may include LiCoPO₄, LiMnPO₄, LiFePO₄, and the like.

Examples of the negative electrode active material may include a metal active material and a carbon active material. Examples of the metal active material may include Li, Si, Sn, and the like. Examples of the carbon active material may include mesocarbon microbeads, highly oriented graphite, hard carbon, soft carbon, and the like.

Examples of the conductive additives may include acetylene black, carbon fiber, and the like.

In addition, the battery member 10 has current collecting foil. The current collecting foil is, for example, aluminum foil for a positive electrode and copper foil for a negative electrode.

In the embodiment, the battery member 10 removed from a used discarded battery and collected is received, and a condition of the received battery member 10 is checked to determine whether it is recyclable or not. Further, the battery member 10 may be a member discarded during the manufacturing process.

The wound body-shaped battery member 10 has, for example, a width of 100 to 300 mm and a length of 5,000 mm. Here, the battery members 10 that are determined to be recyclable are cut into lengths, for example, 500 mm each, to standardize the size and perform separation work of the active material.

The battery member 10a shown in FIG. 2 is formed by cutting the battery member 10 as described above, and is, for example, a strip shape with a width of 300 mm in the upward/downward direction in the drawing and a length of 500 mm in the leftward/rightward direction in the drawing.

As shown in FIG. 2, the battery member 10a is folded at a centerline C in the width direction, and the separation work of the active material 11 is performed. Further, it is preferable that a distance h from the centerline C to both ends of the battery member 10a in the width direction be of equal length.

### Separating Apparatus 30 of Active Material 11

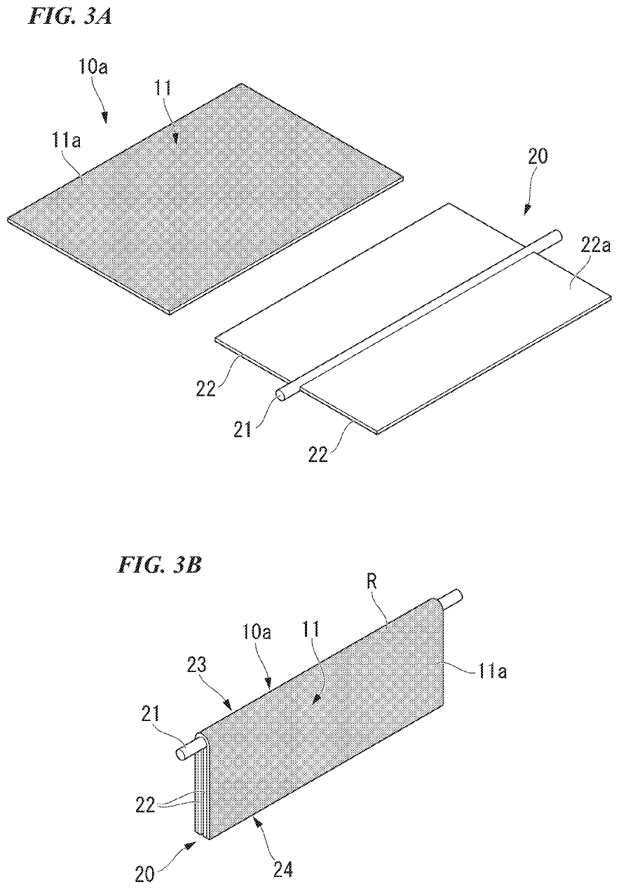

Referring to FIG. 3 to FIG. 5, an apparatus 30 for separating the active material 11 of the embodiment will be described.

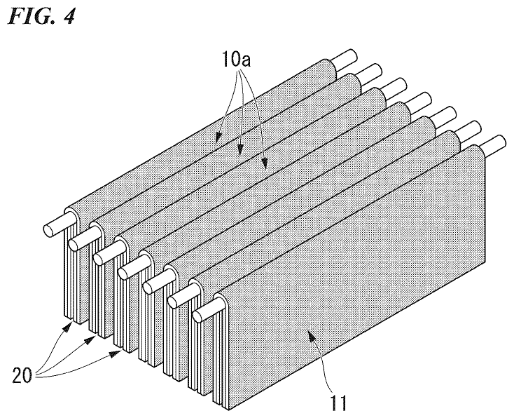

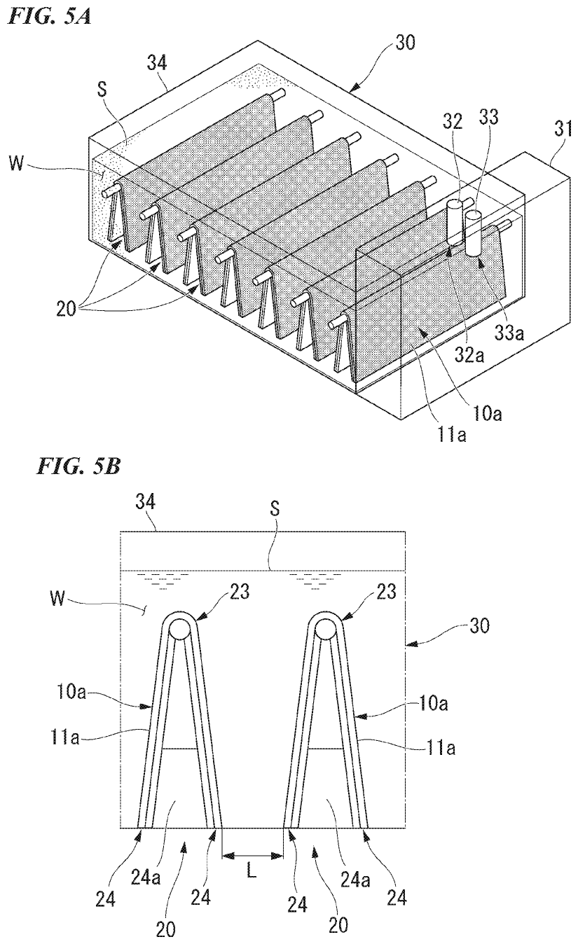

FIG. 3(A) is a perspective view showing state in which a jig 20 provided in the separating apparatus 30 of the embodiment is in a deployment state and line up with the strip-shaped battery member 10a. FIG. 3(B) is a perspective view showing a state in which the folded battery member 10a is attached to the jigs 20 in a folded state. FIG. 4 is a perspective view showing a state in which multiple of the jigs 20 and the battery members 10a in the state of FIG. 3(B) are arranged. FIG. 5(A) is a perspective view showing the separating apparatus 30 of the embodiment. FIG. 5(B) is a side view of a disposition portion of the jigs 20 of the separating apparatus 30.

The separating apparatus 30 is an apparatus for separating the active material 11 from the battery member 10a. As shown in FIG. 5(A), the separating apparatus 30 includes the jigs 20 to which the battery members 10a are attached, a container 34 in which liquid W is stored, and a liquid injection part 31 configured to inject the high-pressure liquid W (injection material) to active material separation surfaces 11a (separation target surface) of the battery members 10a. In addition, separating apparatus 30 includes a control unit (not shown) configured to control equipment inside and outside the container 34.

As shown in FIG. 5(A) and FIG. 5(B), the jigs 20 are used in the separating apparatus 30 to separate the active material 11 from the battery members 10a, and each have a pair of plate members 22 that can be folded around a rotation shaft 21 extending in the length direction. The jig 20 can be formed into a mountain shape by folding the side of the front surface 22a, with the battery member 10a containing the active material 11 attached to front surfaces 22a of the pair of plate members 22. The jig 20 can be folded so that the pair of plate members 22 are parallel to each other, with the battery members 10a containing the active material 11 attached to the front surfaces 22a of the pair of plate members 22.

As shown in FIG. 4, when transporting the plurality of jigs 20, each of the jigs 20 can be folded and arranged so that all of the jigs 20 can be transported efficiently at the same time.

As shown in FIG. 5(A) and FIG. 5(B), the container 34 stores the liquid W inside. The plurality of mountain-shaped jigs 20 are disposed in the liquid W stored in the container 34. The plurality of jigs 20 are disposed with directions of ridgelines R of mountain-shaped top portions 23 aligned in the same direction and at an interval L between foot portions 24 of the mountain-shaped jigs 20. For example, a spacer 24a can be placed between the foot portions 24 to maintain the interval L.

The liquid injection part 31 is disposed on the side of the container 34 and has at least a pair of injection nozzles 32 and 33 configured to inject the high-pressure liquid W. The injection nozzle 32 and the injection nozzle 33 are arranged in a direction that intersects with the ridgeline R of the top portion 23 of the jig 20, extend downward into the container 34, and are provided with a liquid injection part 32a and a liquid injection part 33a at their respective lower ends. The high-pressure liquid W is injected vertically downward from the liquid injection part 32a and the liquid injection part 33a. The liquid injection part 31 allows the injection nozzle 32 and the injection nozzle 33 to move in a direction along the ridgeline R and in a direction that intersects with (perpendicular to) the ridgeline R.

The liquid injection part 32a and the liquid injection part 33a are disposed at a height position where they are submerged in the liquid W in the container 34 when separating the active material 11 from the active material separation surface 11a of the battery member 10. That is, the liquid injection part 32a and the liquid injection part 33a are disposed at a position lower than a liquid surface S of the liquid W stored in the container 34. The top portion 23 (the folded battery member 10a) of the jig 20 is disposed below the liquid injection part 32a and the liquid injection part 33a.

The liquid W injected from the injection nozzle 32 and the injection nozzle 33 may be water (pure water).

The liquid W stored in the container 34 may be the same liquid as the liquid W injected from the injection nozzle 32 and the injection nozzle 33. The liquid W may be introduced into the container 34 through the injection nozzle 32 and the injection nozzle 33, or the liquid W may be introduced from another introduction port (not shown) before the injection of the liquid W from the injection nozzle 32 and the injection nozzle 33 begins.

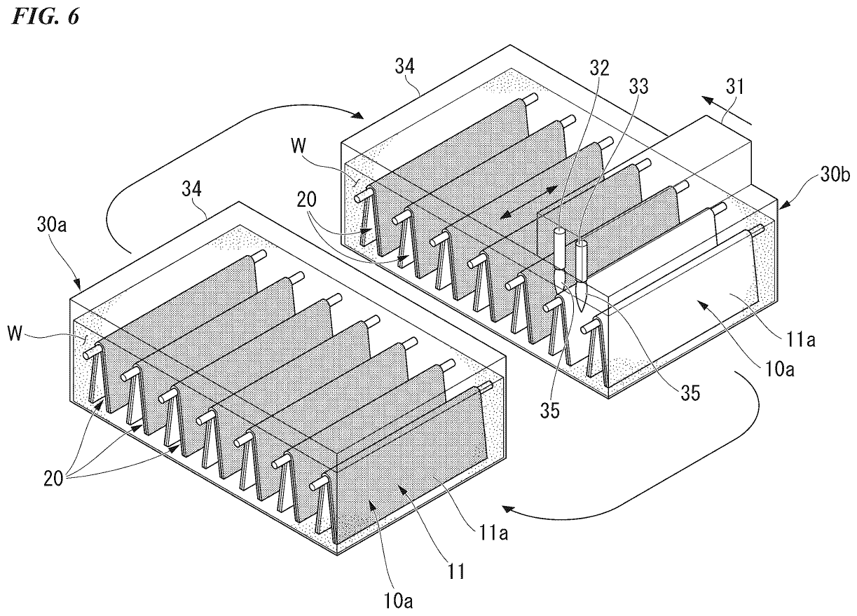

FIG. 6 is a schematic view for describing a process of separating the active material 11 from the battery member 10a of the embodiment.

As shown in FIG. 6, in a separating apparatus 30a in a loading/unloading stage, the plurality of mountain-shaped jigs 20 are disposed in the liquid W stored inside the container 34. In a separating apparatus 30b in a peeling stage, the liquid W is injected onto the battery member 10a attached to the jig 20 disposed inside the container 34 from the injection nozzle 32 and the injection nozzle 33 located above the battery member 10a, and the active material 11 is separated.

When the active material 11 of all the battery members 10a is separated by the separating apparatus 30b in the peeling stage, the separating apparatus 30b is replaced with the separating apparatus 30a in the loading/unloading stage. Then, in the peeling stage, separation work of an active material 11 from a new battery member 10a is performed, and in the loading/unloading stage, the battery member 10a is unloaded after the active material 11 has been separated, and a new battery member 10a is loaded.

In the separating apparatus 30a of the peeling stage, the liquid injection part 31 is moved above the liquid surface S of the liquid W in which the plurality of jigs 20 and the battery member 10a are submerged. After that, the injection nozzle 32 and the injection nozzle 33 are lowered, and the liquid injection part 32a and the liquid injection part 33a of the lower end of the nozzle are moved in the liquid. The liquid W is injected from the liquid injection part 32a and the liquid injection part 33a toward the battery member 10a.

The injection nozzle 32 and the injection nozzle 33 inject the liquid W onto the battery member 10a while moving along the ridgeline R of the top portion 23 of the jig 20. Accordingly, the liquid W is injected onto the battery member 10a over a wide range along the ridgeline R.

In the separating apparatus 30b, when the work of separating the active material 11 from all of the battery members 10a is terminated, the separating apparatus 30b in the peeling stage is replaced with the separating apparatus 30a in the loading/unloading stage, and the separation work of the active material 11 is repeatedly performed.

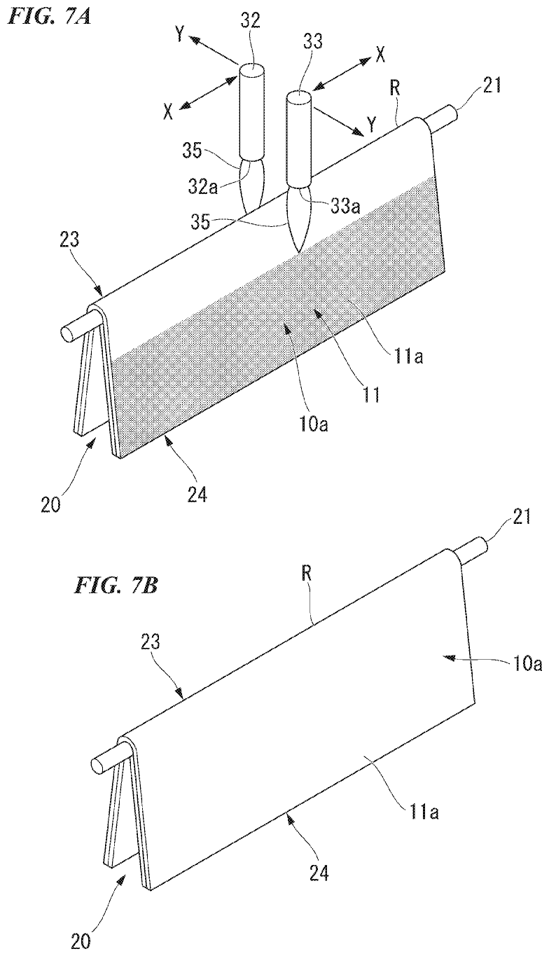

FIG. 7(A) is a perspective view showing an aspect in which the active material 11 is separated from the battery member 10a by injecting the high-pressure liquid W from the injection nozzle 32 and the injection nozzle 33. FIG. 7(B) is a perspective view showing an aspect in which the active material 11 is separated from the battery member 10a.

As shown in FIG. 7(A), the high-pressure liquid W is injected toward the slope of the jigs 20 from the liquid injection part 32a and the liquid injection part 33a of the injection nozzle 32 and the injection nozzle 33, which are disposed at the top portion 23 of the jig 20, to which the battery member 10a is attached, formed in a mountain shape. At this time, the injection nozzle 32 and the injection nozzle 33 inject the liquid W while moving parallel to the direction of the ridgeline R (the X direction in FIG. 7(A)). This action can separate the active material 11 from an upper half of the top portion 23 of the battery member 10a.

After the active material 11 is separated from the upper half of the top portion 23 of the battery member 10a, the injection nozzle is moved (offset) in a direction that intersects with the ridgeline R of the top portion (Y direction in FIG. 7(A)), and the high-pressure liquid W is injected toward the inclined front surfaces of the foot portions 24 of the mountain-shaped jigs 20. At this time, the injection nozzle 32 and the injection nozzle 33 inject the liquid W while moving parallel to the direction opposite to the direction of the parallel movement along the ridgeline R. This operation allows the separation of the active material 11 from the lower half of the battery member 10a on the side of the foot portions 24 without the liquid injection part 32a and the liquid injection part 33a coming into contact with the top portion 23 of the battery member 10a.

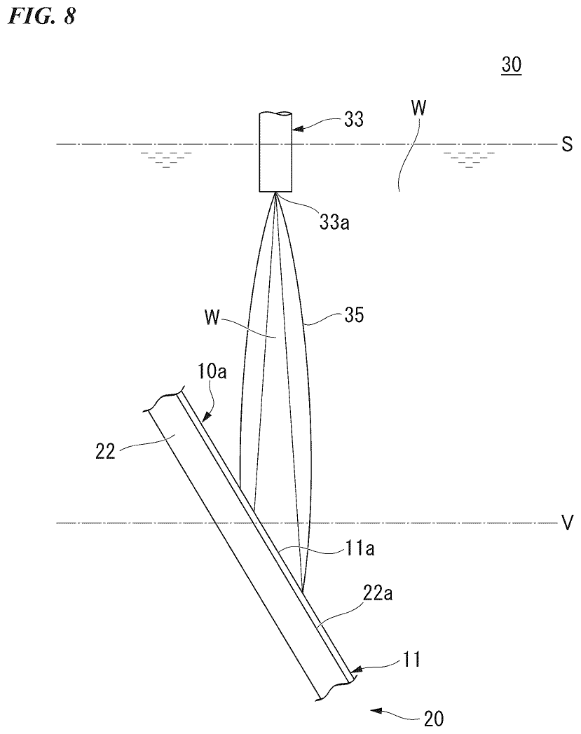

FIG. 8 is a schematic view showing an aspect in which the high-pressure liquid W is injected from the liquid injection part 33a of the injection nozzle 33 to the battery member 10a. In FIG. 8, although the aspect is shown in which the liquid W is injected from the liquid injection part 33a of the injection nozzle 33, the same applies to the case in which the liquid W is injected from the liquid injection part 32a of the injection nozzle 32.

First, the liquid W stored in the container 34 is adjusted so that the height of the liquid surface S is higher than the lower end of the liquid injection part 33a of the injection nozzle 33. The jig 20 and the battery member 10a are disposed below the liquid injection part 33a of the injection nozzle 33 during the separation processing of the active material 11. For this reason, the liquid surface S of the liquid W stored in the container 34 also becomes higher than the upper end of the jig 20 and the battery member 10a. That is, the jig 20 and the battery member 10a are submerged below the liquid surface S of the liquid W in the container 34. Then, the liquid injection part 33a of the injection nozzle 33 is also submerged below the liquid surface S of the liquid W in the container 34. Accordingly, the high-pressure liquid W injected from the liquid injection part 33a of the injection nozzle 33 is injected toward the battery member 10a in the liquid W in the container 34. At this time, since the high-pressure liquid W injected from the liquid injection part 33a does not collide with the liquid surface S in the container 34, the energy of the injected high-pressure liquid W is not significantly attenuated.

When the high-pressure liquid W injected from the liquid injection part 33a of the injection nozzle 33 is injected vertically downward into the liquid W in the container 34, the jet flow of the high-pressure liquid W draws the surrounding liquid W in the container 34 into the jet flow. As a result, the surrounding liquid W of the jet flow becomes low pressure, generating a plurality of fine bubbles. Thus, the plurality of resulting bubbles form a bubble cloud 35 that surrounds the jet flow and move downward. The battery member 10a attached to the plate member 22 of the jig 20 is disposed below the jet flow of the high-pressure liquid W. At this time, the active material separation surface 11a of the battery member 10a is primarily irradiated with the bubble cloud 35 surrounding the jet flow.

As shown in FIG. 8, since the jig 20 is formed in a mountain shape, the active material separation surface 11a of the battery member 10a has a tilt angle of, for example, approximately 60° with respect to a virtual plane v. The bubble cloud 35 irradiated onto the active material separation surface 11a is distributed over a wide range around the jet flow of the high-pressure liquid W, so that the separation of the wide range of the active material occurs at once on the active material separation surface 11a.

In the embodiment, since the battery member 10a is held so that the active material separation surface 11a has a tilt angle of approximately 60° with respect to the virtual plane v, the jet flow of the high-pressure liquid W does not hit the active material separation surface 11a at a right angle, and the bubble cloud 35 around the jet flow is irradiated over a wider area of the active material separation surface 11a at once.

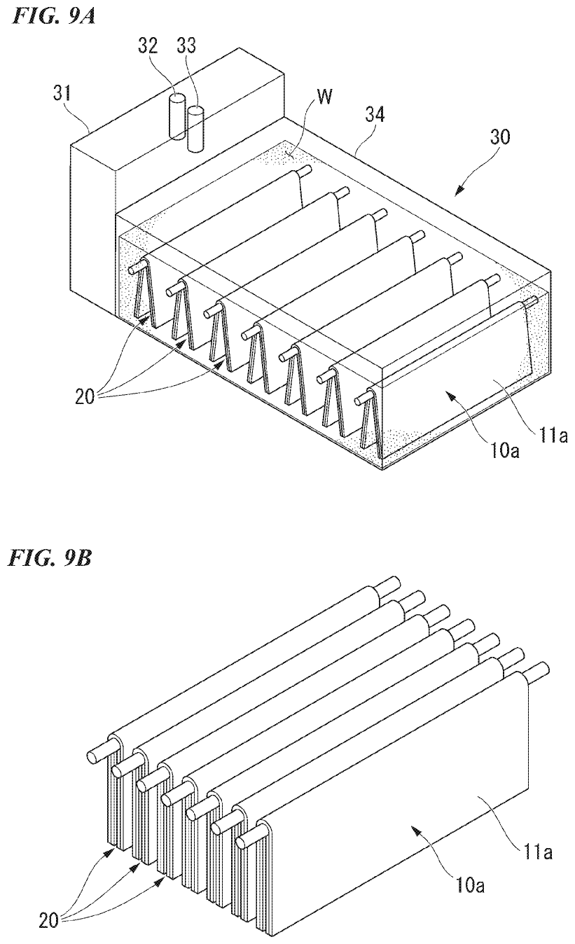

FIG. 9(A) is a perspective view showing a state in which the separation work of the active material 11 in the separating apparatus 30 is terminated. FIG. 9(B) is a perspective view showing a state in which the plurality of jigs 20 removed from the separating apparatus 30 and folded are arranged.

As shown in FIG. 9(A), immediately after the separation work of the active material 11 is terminated, the plurality of mountain-shaped jigs 20 are disposed inside the container 34. When removing these jigs 20 from the container 34, as shown in FIG. 9(B), by folding and arranging each of the jigs 20, all of the jigs 20 can be removed from the container 34 at the same time. This operation allows, for example, 10 sets of the jigs 20 to be removed simultaneously in a few seconds.

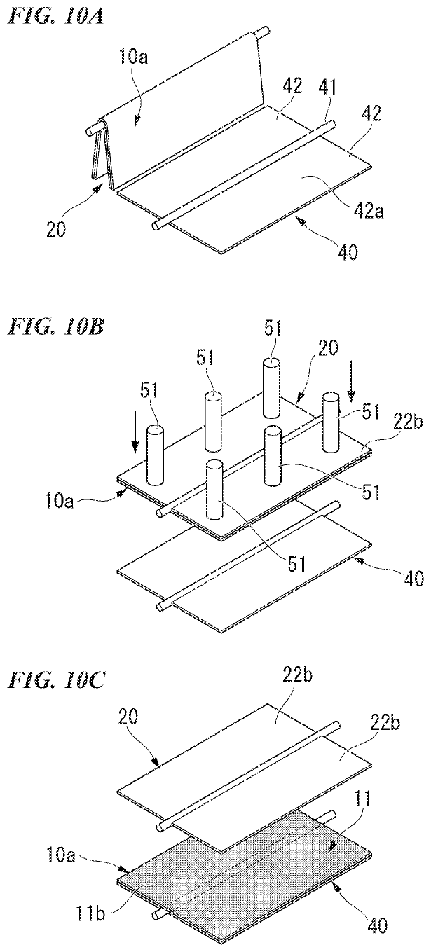

FIG. 10(A), FIG. 10(B) and FIG. 10(C) are schematic views for describing a process of turning the battery member 10a attached to the jig 20 upside down and attaching the battery member 10a to another jig 40. FIG. 10(A) is a perspective view describing a first process of overlapping the jig 20, to which the battery member 10a on which the separation work of the active material 11 on the front surface is terminated is attached, with the other jig 40. FIG. 10(B) is a perspective view for describing a second process of removing the battery member 10a from the jig 20 overlapping with the jig 40. FIG. 10(C) is a perspective view for describing a third process of moving the jig 20 and attaching the battery member 10a to the other jig 40. The configuration of the jig 40 is the same as that of the jig 20.

As shown in FIG. 10(A), the jig 20, which has been flattened after the separation work and then turned upside down, is overlapped with front surfaces 42a of the jig 40, which has been flattened. At this time, the front surfaces 22a of the jig 20 to which the battery member 10a is attached face the front surfaces 42a of the jig 40. In addition, the rotation shaft 21 of the jig 20 is aligned with a rotation shaft 41 of the jig 40, and the pair of plate members 22 of the jig 20 are aligned with a pair of plate members 42 of the jig 40.

As shown in FIG. 10(B), after the front surfaces 22a of the jig 20 and the front surfaces 42a of the jig 40 are overlapped with each other with the battery member 10a sandwiched between them, the battery member 10a is removed from the jig 20 by pressing back surfaces 22b of the plate members 22 with a plurality of removal rods 51. For example, the plate members 22 are formed with holes through which the removal rods 51 pass.

As shown in FIG. 10(C), the battery member 10a removed from the jig 20 is attached to the front surfaces 42a of the jig 40 as it is. According to this operation, an active material separation surface 11b of the battery member 10a, from which the active material 11 has not been separated, is disposed on the side of the front surfaces 42a of the jig 40. After that, the jig 40 is used to separate the active material 11 from the active material separation surface 11b of the battery member 10a.

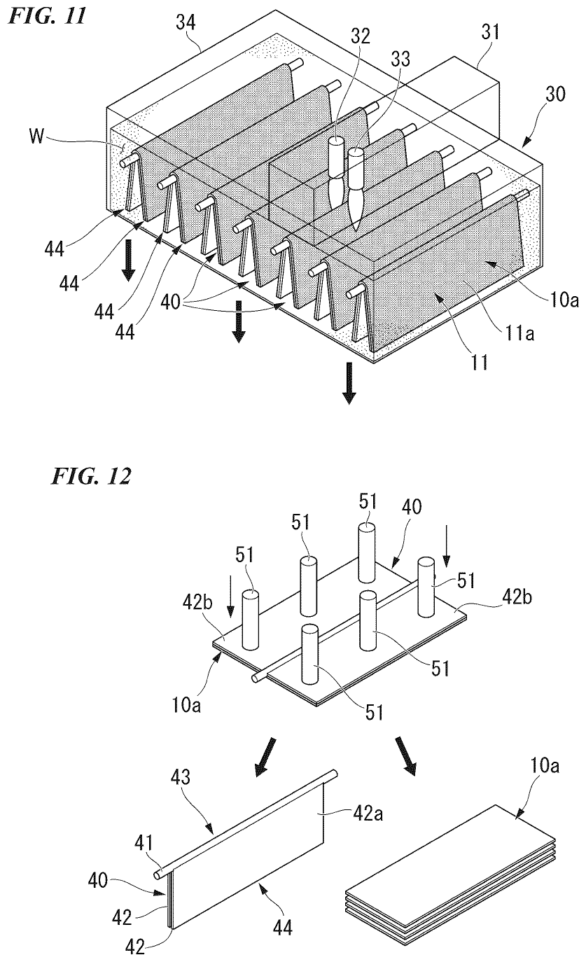

FIG. 11 is a schematic view for describing a process of separating an active material of the battery member 10a attached to the other jig 40.

As shown in FIG. 11, like the jigs 20, the plurality of jigs 40 to which the battery members 10a are attached are also formed into mountain shapes, and are disposed in the liquid W in the container 34. At this time, the plurality of jigs 40 are disposed with the ridgelines R of the mountain-shaped top portions 43 aligned in the same direction and foot portions 44 of the mountain-shaped jigs 40 spaced apart by the interval L.

After that, the active material 11 is separated from the battery member 10a by the high-pressure liquid W injected from the injection nozzle 32 and the injection nozzle 33. Then, the separated active material 11 is discharged downward into the container 34 from a space between the foot portions 44 spaced apart by the interval L.

FIG. 12 is a schematic view for describing a process of removing the battery member 10a, from which the active material 11 of the active material separation surface 11b is separated, from the other jig 40 and separating the battery member 10a from the jig 40.

As shown in FIG. 12, the battery member 10a is removed from the jig 40 by pressing the back surfaces 42b of the plate members 42 of the jig 40 with the plurality of removal rods 51.

The jigs 40 from which the battery members 10a have been removed are folded and transported together, and the removed battery members 10a (with the active material 11 separated) are transported together in groups.

### Method of Separating Active Material 11

Next, a method of separating an active material 11 of the embodiment will be described with reference to FIG. 1 to FIG. 13.

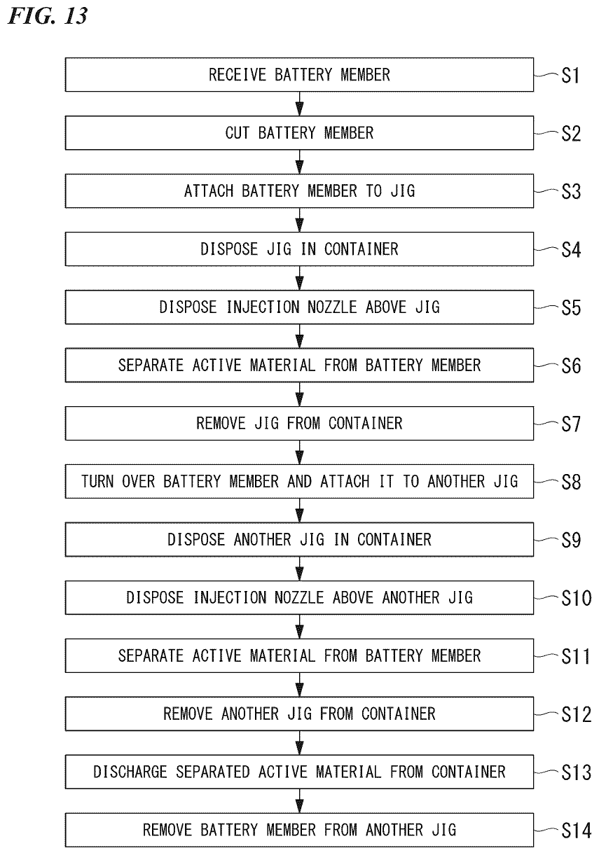

FIG. 13 is a flowchart showing the method of separating the active material 11 of the embodiment.

In a process S1, a battery member 10 that has been removed from a used battery or discarded in a manufacturing process is received, and a condition of the battery member 10 is checked to determine whether it can be recycled.

In a process S2, the battery member 10 that has been determined to be recyclable is cut to a predetermined uniform size as necessary, and is designated as a battery member 10a.

In a process S3, the battery member 10a containing the active material 11 is attached to the front surfaces 22a of the foldable jig 20. At this time, before or after the battery member 10a is attached, the jig 20 is formed into a mountain shape by folding the side of the front surfaces 22a.

In a process S4, the mountain-shaped jigs 20, to which the battery members 10a are attached, are input into the container 34 in which the liquid W in the apparatus 30 for separating the active material 11 is stored, with the mountain-shaped top portion 23 facing upward, and are disposed multiple times in the liquid in the container 34. The plurality of jigs 20 disposed inside the container 34 are disposed with the ridgelines R of the top portions 23 aligned in the same direction and the foot portions 24 of the mountain-shaped jigs 20 spaced apart by the interval L.

In a process S5, above the jig 20 disposed in the separating apparatus 30, the injection nozzle 32 and the injection nozzle 33, which are configured to inject high-pressure liquid W onto an active material separation surface 11a of the battery member 10a, are disposed at positions symmetrical with respect to the ridgeline R of the mountain-shaped top portion 23, respectively. The injection nozzle 32 and the injection nozzle 33 dispose the liquid injection part 32a and the liquid injection part 33a, respectively, into the liquid in the container 34, and inject the high-pressure liquid W onto the battery member 10a in the liquid.

In a process S6, the high-pressure liquid W is injected from the liquid injection part 32a and the liquid injection part 33a of the injection nozzle 32 and the injection nozzle 33 toward the tilted front surfaces 22a of the mountain-shaped jig 20, separating the active material 11 from the battery member 10a. At this time, the injection nozzle 32 and the injection nozzle 33 are moved parallel to the ridgeline R of the top portion 23, and the high-pressure liquid W is simultaneously and symmetrically injected from the liquid injection part 32a and the liquid injection part 33a toward the tilted front surfaces 22a of the mountain-shaped jig 20. After that, the injection nozzle 32 and the injection nozzle 33 are moved in a direction that intersects with the ridgeline R of the top portion 23, and the high-pressure liquid W is injected toward the tilted front surfaces 22a on the side of the foot portions 24 of the mountain-shaped jig 20. By injecting the injection material while moving the injection nozzles 32, 33 parallel to the ridgeline of the top portion, it is possible to inject the injection material over a wide range along the ridgeline. For this reason, it is possible to perform the separation processing more efficiently than when injecting with a fixed injection nozzle. In addition, by offsetting the injection nozzles 32, 33 from the top portion and injecting the injection material onto the front surface of the battery member near the foot portions, it is possible to inject over a wider range, enabling efficient separation processing. Moreover, by injecting the injection material symmetrically from the injection nozzles 32, 33 disposed at positions symmetrical with respect to the two ridgeline R simultaneously, it is possible to prevent the battery member from shifting or moving during operation.

In a process S7, after separating the active material 11 from the battery members 10a, the jigs 20 are removed from the container 34. At this time, the plurality of jigs 20 are folded and arranged, and all of the jigs 20 are removed from the container 34 at the same time.

In a process S8, the battery members 10a are turned over, and attached to the other jigs 40 from the jigs 20. At this time, after the front surfaces 22a of the jigs 20 and the front surfaces 42a of the jigs 40 are overlapped with each other with the battery members 10a sandwiched between them, the battery members 10a are removed from the jigs 20 by pressing the back surfaces 22b of the plate members 22 with the plurality of removal rods 51. Then, the removed battery members 10a are attached to the other jigs 40 from the jigs 20 as they are.

In a process S9, similar to the process S4, the plurality of mountain-shaped jigs 40 to which the battery members 10a are attached are disposed in the liquid in the container 34.

In a process S10, similar to the process S5, the injection nozzle 32 and the injection nozzle 33 are disposed above the jigs 40 disposed in the separating apparatus 30.

In a process S11, similar to the process S6, the active material 11 is separated from the active material separation surface 11b of the battery member 10a.

In a process S12, similar to the process S7, after the active material 11 is separated from the active material separation surface 11b of the battery member 10a, the jigs 40 are removed from the container 34.

In a process S13, the separated active material 11 is discharged downward into the container 34 from between the foot portions 44 of the plurality of jigs 40 spaced apart by the interval L. At this time, for example, the separated active material 11 is discharged downward into the container 34 using slurry.

In a process S14, the battery members 10a are removed from the jigs 40 by pressing the back surfaces 42b of the plate members 42 of the jigs 40 with the plurality of removal rods 51. After that, the jigs 40 from which the battery members 10a have been removed are folded and transported together, and the removed battery members 10a are transported together in groups of several.

In one embodiment of the present invention, since the ridgeline directions of the top portions of the jigs are aligned in the same direction, by moving the plurality of injection nozzles corresponding to the plurality of jigs in the same direction, separation work can be performed efficiently for the battery members attached to the jigs. In addition, the jig is disposed with intervals between the foot portions, making it easy to discharge the separated active material.

In addition, the jig used in the apparatus for separating the active material that separates the active material from the battery member has the pair of foldable plate members, the battery member containing the active material can be attached to the surfaces of the plate members, and the surface side can be folded in the mountain shape. Before and after attaching the battery member containing the active material to the front surface of the plate member, the side of the front surfaces is folded to form the mountain shape. The jig can be folded for easy transport and can be easily disposed in the mountain shape within the apparatus for separating the active material. The battery member may be attached to the jig before folding, or to the jig in the mountain shape. Accordingly, the separation work of the active material of the battery member can be continuously and efficiently performed.

The order of the above-mentioned processes S1 to S14 can be changed as needed depending on the work situation. In addition, when the active material 11 is separated from only one surface of the battery member 10a (for example, the active material separation surface 11a), the process S8 to the process S12 can be omitted. In this case, the process S13 and the process S14 can use the jig 20 instead of the jig 40.

Although one embodiment of the present invention has been described, this embodiment is presented as an example and is not intended to limit the scope of the invention. This embodiment can be implemented in various other forms, and various omissions, substitutions, and modifications may be made without departing from the spirit of the invention. For example, in the embodiment of the present invention, although an example has been disclosed in which the jigs 20 to which the battery members 10a are attached are disposed in the liquid and the liquid is injected from the injection nozzles 32 and 33, it is also possible to separate the active material 11 by injecting the liquid from the injection nozzles 32 and 33 without disposing the jigs 20 in the liquid. In addition, instead of liquid, particles such as dry ice or ice may be injected to separate the active material 11. This embodiment and its variants are intended to be included within the scope and spirit of the invention as defined in the claims and their equivalents.

### BRIEF DESCRIPTION OF THE REFERENCE SYMBOLS

10, 10a Battery member
11 Active material
11a, 11b Active material separation surface
20, 40 Jig
21, 41 Rotation shaft
22, 42 Plate member
22a, 42a Front surface
22b, 42b Back surface
23, 43 Top portion
24, 44 foot portions
30, 30a, 30b Separation apparatus
31 Liquid injection part
32, 33 Injection nozzle
32a, 33a Liquid injection part
34 Container
35 Bubble cloud
51 Removal rod
R Ridgeline
S Liquid surface
v Virtual plane
W Liquid (injection material)

What is claimed is:

1. A method of separating an active material, comprising:
a process of attaching a battery member containing an active material to a front surface of a foldable jig;
a process of folding a side of the front surface of the jig before and after the battery member is attached thereto to form a mountain shape;
a process of disposing the jig to which the battery member is attached in an apparatus for separating an active material with the mountain-shaped top portion facing upward;
a process of disposing an injection nozzle configured to inject an injection material containing liquid or particles onto an active material separation surface of the battery member above the jig disposed in the separating apparatus; and
a process of injecting the injection material from the injection nozzle toward tilted front surfaces of the mountain-shaped jig and separating the active material from the battery member.

2. The method of separating the active material according to claim 1, wherein the process of separating the active material comprises a process of moving the injection nozzle parallel to a ridgeline of the top portion and injecting the injection material from the injection nozzle toward the tilted front surfaces of the mountain-shaped jig.

3. The method of separating the active material according to claim 1, wherein the process of separating the active material comprises a process of moving the injection nozzle in a direction that intersects with the ridgeline of the top portion after injecting the injection material from the injection nozzle toward the tilted front surfaces of the mountain-shaped jig, and injecting the injection material toward the tilted front surfaces on the side of foot portions of the mountain-shaped jig.

4. The method of separating the active material according to claim 1, wherein the process of disposing the injection nozzle comprises a process of disposing the injection nozzles on symmetrical positions relative to the ridgeline of the top portion, respectively, and
the process of separating the active material comprises a process of injecting the injection material simultaneously and symmetrically toward the tilted front surfaces of the mountain-shaped jig from the injection nozzles disposed on the symmetrical positions, respectively.

5. The method of separating the active material according to claim 1, further comprising: a process of inputting the jigs to which the battery members are attached in a container in which liquid is stored, and disposing the jigs in the liquid in the container,
wherein the injection nozzle has a liquid injection part disposed in the liquid in the container, and injects the liquid injection material onto the battery member in the liquid.

6. The method of separating the active material according to claim 5, further comprising: a process of disposing the mountain-shaped jigs in the container multiple times,
wherein the plurality of jigs disposed inside the container are disposed with the ridgelines of the top portions aligned in the same direction and with intervals between the foot portions of the mountain-shaped jigs.

7. A jig having a pair of foldable plate members, a battery member containing an active material being attachable to front surfaces of the plate members, the side of the front surfaces being folded to form a mountain shape, the jig being used in an active material separating apparatus for separating the active material from the battery member.

8. An apparatus for separating an active material, the apparatus comprising:
a jig having a pair of foldable plate members, a battery member containing an active material being attachable to front surfaces of the plate members, the side of the front surfaces being folded in a mountain shape; and
an injection nozzle configured to inject an injection material containing liquid or particles onto an active material separation surface of the battery member,
wherein the injection material is injected from the injection nozzle toward the tilted front surfaces of the mountain-shaped jig, separating the active material from the battery member.
